(19) United States
(12) Patent Application Publication
(10) Pub. No.: US 2024/0320305 A1
(43) Pub. Date: Sep. 26, 2024

(54) INFORMATION PROCESSING METHOD, INFORMATION PROCESSING APPARATUS, AND COMPUTER PROGRAM PRODUCT

(71) Applicant: KABUSHIKI KAISHA TOSHIBA, Tokyo (JP)

(72) Inventor: Yoshikazu HANATANI, Komae Tokyo (JP)

(73) Assignee: KABUSHIKI KAISHA TOSHIBA, Tokyo (JP)

(21) Appl. No.: 18/521,205

(22) Filed: Nov. 28, 2023

(30) Foreign Application Priority Data
Mar. 22, 2023 (JP) 2023-044880

(51) Int. Cl. G06F 18/22

(52) U.S. Cl. CPC G06F 18/22

(57) ABSTRACT

According to an embodiment, an information processing method is executed by a computer. The method includes generating processed data obtained by processing original data including a group of a plurality of data values arranged respectively at position coordinates along a predetermined direction on a map, using a processing pattern in which a processing rule of the original data is defined for each position coordinate on the map.

### CROSS-REFERENCE TO RELATED APPLICATIONS

This application is based upon and claims the benefit of priority from Japanese Patent Application No. 2023-044880, filed on Mar. 22, 2023; the entire contents of which are incorporated herein by reference.

### FIELD

Embodiments described herein relate generally to an information processing method, an information processing apparatus, and a computer program product BACKGROUND

Analysis of original data is requested to an analysis institution. Furthermore, in order to suppress confidential leakage of original data, the original data is processed and then requested to an analysis institution. For example, the original data is divided into a plurality of pieces of data, and only a part of the data is disclosed to each of a plurality of the analysis institutions to request analysis. Furthermore, a chip range which is an analysis target region arranged on a wafer is detected by edge detection, processing of deleting data of an outer periphery of the detected chip range is performed, and then analysis is requested.

However, conventionally, there has been a case where an increase in a calculation amount regarding data processing for suppressing leakage of confidential information becomes a problem.

### BRIEF DESCRIPTION OF THE DRAWINGS

FIG. 1 is a schematic diagram of an information processing system;

FIG. 2 is a block diagram of a functional configuration of an information processing apparatus;

FIG. 3A is an explanatory diagram of original data;

FIG. 3B is an explanatory diagram of original data;

FIG. 4A is an explanatory diagram of processing pattern information;

FIG. 4B is an explanatory diagram of processing pattern information;

FIG. 5A is an explanatory diagram of processing of original data;

FIG. 5B is an explanatory diagram of processing of original data;

FIG. 5C is an explanatory diagram of processing of original data;

FIG. 5D is an explanatory diagram of processing of original data;

FIG. 6 is a flowchart of a flow of information processing executed by the information processing apparatus;

FIG. 7 is a flowchart of a flow of processing executed by a processing unit;

FIG. 8 is a block diagram of a functional configuration of the information processing apparatus;

FIG. 9A is an explanatory diagram of a replacement function;

FIG. 9B is an explanatory diagram of position coordinates before and after replacement;

FIG. 10A is an explanatory diagram of a coordinate replacement process;

FIG. 10B is an explanatory diagram of a coordinate replacement process;

FIG. 10C is an explanatory diagram of a coordinate replacement process;

FIG. 10D is an explanatory diagram of a coordinate replacement process;

FIG. 11A is an explanatory diagram of processing of shuffled data;

FIG. 11B is an explanatory diagram of processing of shuffled data;

FIG. 11C is an explanatory diagram of processing of shuffled data;

FIG. 11D is an explanatory diagram of processing of shuffled data;

FIG. 12 is a flowchart of a flow of information processing executed by the information processing apparatus;

FIG. 13 is a flowchart of a flow of a shuffling process executed by a coordinate replacement section; and

FIG. 14 is a hardware configuration diagram.

### DETAILED DESCRIPTION

According to an embodiment, an information processing method is executed by a computer. The method includes generating processed data obtained by processing original data including a group of a plurality of data values arranged respectively at position coordinates along a predetermined direction on a map, using a processing pattern in which a processing rule of the original data is defined for each position coordinate on the map.

Hereinafter, an information processing apparatus, an information processing method, and an information processing program will be described in detail with reference to the accompanying drawings.

### First Embodiment

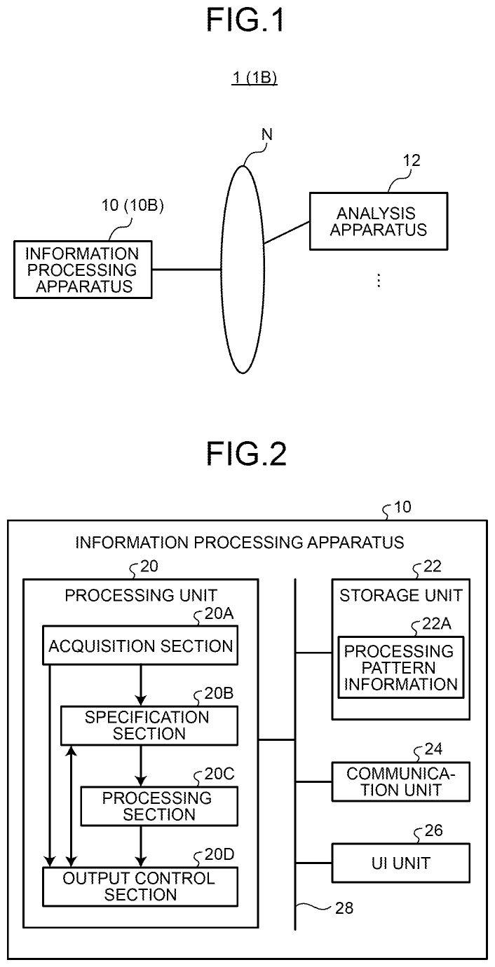

FIG. 1 is a schematic diagram illustrating an example of an information processing system 1 according to the present embodiment.

The information processing system 1 includes an information processing apparatus 10 and an analysis apparatus 12. The information processing apparatus 10 and the analysis apparatus 12 are communicably connected via a wireless or wired communication network such as a network N.

The information processing apparatus 10 is a dedicated or general-purpose computer. The information processing apparatus 10 is an apparatus that requests the analysis apparatus 12 to analyze original data. Details of the original data will be described later.

The analysis apparatus 12 is a dedicated or general-purpose computer. The analysis apparatus 12 is an analysis apparatus that analyzes data received from the information processing apparatus 10. The information processing system 1 may include a plurality of analysis apparatuses 12. The plurality of analysis apparatuses 12 are managed by different companies, individuals, or groups, for example.

FIG. 2 is a block diagram illustrating an example of a functional configuration of the information processing apparatus 10.

The information processing apparatus 10 includes a processing unit 20, a storage unit 22, a communication unit 24, and a user interface (UI) unit 26. The processing unit 20, the storage unit 22, the communication unit 24, and the UI unit 26 are connected via a bus 28 so as to be able to exchange data or signals.

Note that at least one of the storage unit 22, the communication unit 24, and the UI unit 26 may be connected to the processing unit 20 via the network N. That is, at least one of the storage unit 22, the communication unit 24, and the UI unit 26 may be provided in an external device connected to the information processing apparatus 10 via the network N. Furthermore, at least one of functional units described later included in the processing unit 20 may be provided in the external device. The external device is, for example, an external server.

The storage unit 22 stores various data. In the present embodiment, the storage unit 22 stores processing pattern information 22A. Details of the processing pattern information 22A will be described later. Furthermore, the storage unit 22 may store processed data, various parameters, and the like that are processing results by the processing unit 20 described later. Details of the processed data will be described later.

The storage unit 22 is, for example, a random access memory (PAU), a semiconductor memory element such as a flash memory, a hard disk, an optical disk, or the like. Note that the storage unit 22 may be a storage device provided outside the information processing apparatus 10. Furthermore, the storage unit 22 may be a storage medium. Specifically, the storage medium may store or temporarily store a program or various types of information downloaded via a local area network (LAN), the Internet, or the like. Furthermore, the storage unit 22 may include a plurality of storage media.

The communication unit 24 communicates with each of the plurality of analysis apparatuses 12 and the external device via the network N. For example, the communication unit 24 transmits various types of information to the analysis apparatuses 12 or receives various types of information from the analysis apparatuses 12.

The UI unit 26 has a function of receiving an operation input by a user and a function of outputting various types of information.

For example, the UI unit 26 includes a display and an input unit. The display displays various types of information. The display is, for example, a known organic electro-luminescence (EL) display, a liquid crystal display (LCD), a projection device, or the like. The input unit receives various instructions from the user. An input unit 10E is, for example, a keyboard, a mouse, a touch panel, a microphone, or the like. Note that the UI unit 26 may be configured by a touch panel including an input mechanism and an output mechanism. Furthermore, the UI unit 26 may further include a speaker that outputs sound.

The processing unit 20 includes an acquisition section 20A, a specification section 20B, a processing section 20C, and an output control section 20D. At least one of the acquisition section 20A, the specification section 20B, the processing section 20C, and the output control section 20D is realized by, for example, one or a plurality of processors. For example, each of the above units may be realized by causing a processor such as a central processing unit (CPU) to execute a program, that is, by software. Each of the above units may be realized by a processor such as a dedicated integrated circuit (IC), that is, hardware. Each of the above units may be realized by using software and hardware in combination. In the case of using a plurality of processors, each processor may implement one of the respective units, or may implement two or more of the respective units.

The acquisition section 20A acquires a plurality of pieces of original data.

The original data is data to be analyzed. In other words, the original data is data that is a source of a request for analysis to the analysis apparatus 12.

The analysis target is, for example, an article to be analyzed. The article is, for example, an electrical appliance, a vehicle, an electrical appliance, a component mounted on a vehicle, or the like, but is not limited thereto. The component is, for example, but not limited to, an electronic circuit, a silicon wafer, or the like. Note that the analysis target is not limited to the article, and may be a group of data classified according to a predetermined classification rule. In the present embodiment, it is assumed that the analysis target is a silicon wafer on which a plurality of chips is mounted.

The original data includes a group of a plurality of data values arranged respectively at position coordinates along a predetermined direction on the map. The map is a unit of data to be analyzed of the original data, and means a state in which a data value included in the original data is arranged in a one-dimensional space or a K-dimensional space. K is an integer of 1 or more. The data value is a state value representing a state of each position coordinate.

In the present embodiment, a form in which the map is a two-dimensional map arranged in a two-dimensional space will be described as an example. Therefore, in the present embodiment, a mode in which the predetermined direction that is the arrangement direction of the data values on the map is a K-dimensional direction (K=2 in the present embodiment) including a first direction on the map and a second direction intersecting the first direction will be described as an example. The description will be given assuming that the first direction is an x-axis direction and the second direction is a y-axis direction orthogonal to the x-axis direction. That is, in the present embodiment, a mode in which the data values included in the original data are arranged respectively at position coordinates represented by the x coordinates and the y coordinates orthogonal to each other of the map represented by the two-dimensional space will be described as an example. Furthermore, in the present embodiment, a mode in which the map is a two-dimensional map along the plate surface of the silicon wafer to be analyzed will be described as an example. Furthermore, in the present embodiment, a mode in which the map has a square shape along a two-dimensional plane will be described as an example. Note that the shape of the map is not limited to a square shape.

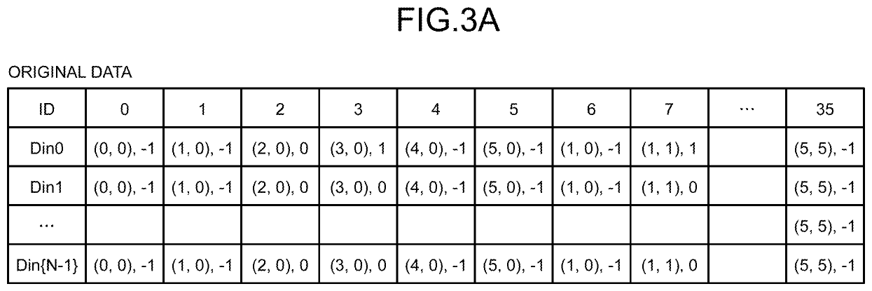

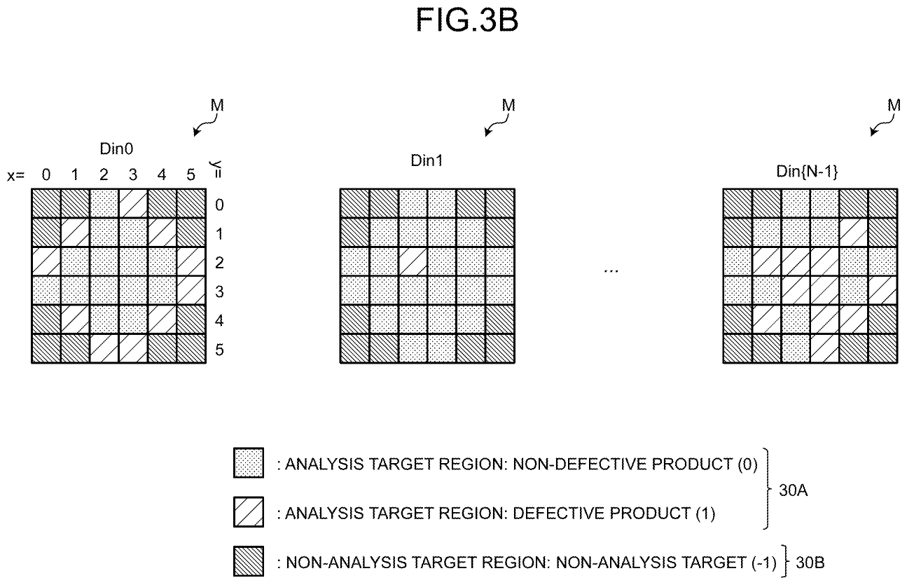

FIGS. 3A and 3B are explanatory diagrams of an example of the original data 35 Din. FIG. 3A is a schematic diagram illustrating an example of a data format of each of a plurality of pieces of the original data Din acquired by the acquisition section 20A. FIG. 3B is an image diagram illustrating the original data Din arranged on the map M.

FIGS. 3A and 3B illustrate N pieces of original data Din from the original data Din0 to the original data Din{N−1} as an example. N is an integer of 1 or more, and corresponds to the number of pieces of original data Din acquired by the acquisition section 20A as a unit of a processing target. That is, the acquisition section 20A acquires N pieces of original data Din={Din0, . . . , Din{N−1}} as processing targets. Furthermore, in the present embodiment, a mode in which the acquisition section 20A acquires the original data Din including data values arranged at each of two-dimensional position coordinates, that is, the original data Din of two-dimensional data will be described as an example.

FIG. 3A illustrates, as an example, a data configuration in which an ID that is identification information of the original data Din is associated with a plurality of pieces of data constituting the original data Din identified by the ID. In FIG. 3A, the numbers 0, 1, 2, 3, 4, 5, 6, 7, . . . , and Num−1 given along the horizontal axis are numbers given to the respective data values included in the original data Din, and correspond to identification numbers of the data values of the respective position coordinates. Num is the number of pieces of data of the data value included in the original data Din. The number of pieces of data of the data values constituting the original data Din may be described as a data size. For example, in a case where the original data Din has a square shape with x coordinates of 0, 1, . . . , and n−1 and y coordinates of 0, 1, . . . , and n−1, Num=n*n−1.

For example, each of the plurality of pieces of data constituting the original data Din is represented by ((x, y), v_Din_j). x represents an x coordinate value, and y represents a y coordinate value. v_Din_j represents a data value defined in the position coordinates (x, y). Furthermore, in a case where the shape has a square shape in which the x coordinate is 0, 1, . . . , n−1 and the y coordinate is 0, 1, . . . , n−1, it can be expressed as ((x, y), v_Din_{x+ny}).

In the present embodiment, a case where the data value included in the original data Din is a data value representing either an analysis target region 30A or a non-analysis target region 30B will be described as an example.

The analysis target region 30A is a region in which data values to be analyzed are arranged on the map M. In the present embodiment, a case where the analysis target region 30A represents a region where chips are arranged in the map M representing a silicon wafer will be described as an example.

Furthermore, in the present embodiment, a case where a value representing a state of a chip arranged at each position coordinate in the analysis target region 30A is defined as a data value of each position coordinate in the analysis target region 30A in the map M in the original data Din will be described. Examples of the value representing the state of the chip include a data value representing an inspection result of the chip. In the present embodiment, it is assumed that a data value representing an inspection result is defined as a data value representing a chip state at each position coordinate in the analysis target region 30A of the original data Din. The data value indicating the inspection result of the chip is, for example, “0” indicating that the chip is a non-defective product or “1” indicating that the chip is a defective product.

Note that the data value representing the inspection result of the chip is not limited to “0” and “1”. Furthermore, the data value of each of the position coordinates in the analysis target region 30A is not limited to the data value representing the inspection result of the chip.

The non-analysis target region 30B is a region in which data values not to be analyzed are arranged on the map M. In the present embodiment, a case where the non-analysis target region 30B represents a region where no chip is arranged in the map M representing the silicon wafer will be described as an example. Specifically, a description will be given on the assumption that a data value “−1” representing non-analysis target is defined for each position coordinate in the non-analysis target region 30B on the map M. Note that the data value indicating non-analysis target is not limited to “−1”.

Therefore, the present embodiment will be described assuming a case where any of “0” representing a non-defective product, “1” representing a defective product, and “−1” representing non-analysis target is defined as the data value v_Din_j, which is a state value representing a state defined in each of the position coordinates (x, y) of the original data Din.

That is, in the present embodiment, the data value of the position coordinates (x, y) represented by the data ((x, y), v_Din_j=0) included in the original data Din represents the chip state “non-defective product”. Furthermore, the data value of the position coordinates (x, y) represented by the data ((x, y), v_Din_j=1) included in the original data Din represents the chip state “defective product”. Furthermore, the data value of the position coordinates (x, y) represented by ((x, y), v_Din_j=−1) represents the state “not to be analyzed” of the chip. Note that these data formats are examples, and may be other data formats.

The acquisition section 20A acquires a group of a plurality of pieces of original data Din to be processed from another external information processing apparatus or the like via the network N. Furthermore, the acquisition section 20A may acquire a plurality of pieces of original data Din by reading a group of a plurality of pieces of original data Din to be processed stored in the storage unit 22. The output control section 20D outputs the plurality of pieces of original data Din acquired by the acquisition section 20A to the specification section 20B as a processing target unit. Note that it is assumed that the original data Din included in the group of the plurality of pieces of original data Din to be processed acquired by the acquisition section 20A have the same data size and the same number of pieces of data in the analysis target region 30A.

In the present embodiment, a description will be given assuming that the acquisition section 20A acquires a group of the plurality of pieces of original data Din0 to Din{N−1} illustrated in FIGS. 3A and 3B as a processing unit.

Returning to FIG. 2, the description will be continued.

The specification section 20B specifies the processing pattern Pd used for processing the plurality of pieces of original data Din acquired by the acquisition section 20A. The specification section 20B specifies one processing pattern Pd for a group of the plurality of pieces of original data Din to be processed acquired by the acquisition section 20A.

The processing pattern Pd is a pattern in which a processing rules of the original data Din is defined for each position coordinate in the map M. The processing unit 20 generates the processed data Dout by processing each data value of the position coordinates included in the original data Din according to the processing rule indicated by the processing pattern Pd. The processing pattern Pd is a pattern in which this processing rule is defined in advance.

Specifically, the processing pattern Pd is a pattern defining a processing rule for processing a data value in the original data Din into a processed data value in the processed data Dout obtained by processing the original data Din as a state value for each position coordinate of the map M.

The specification section 20B specifies the processing pattern Pd from the processing pattern information 22A stored in the storage unit 22.

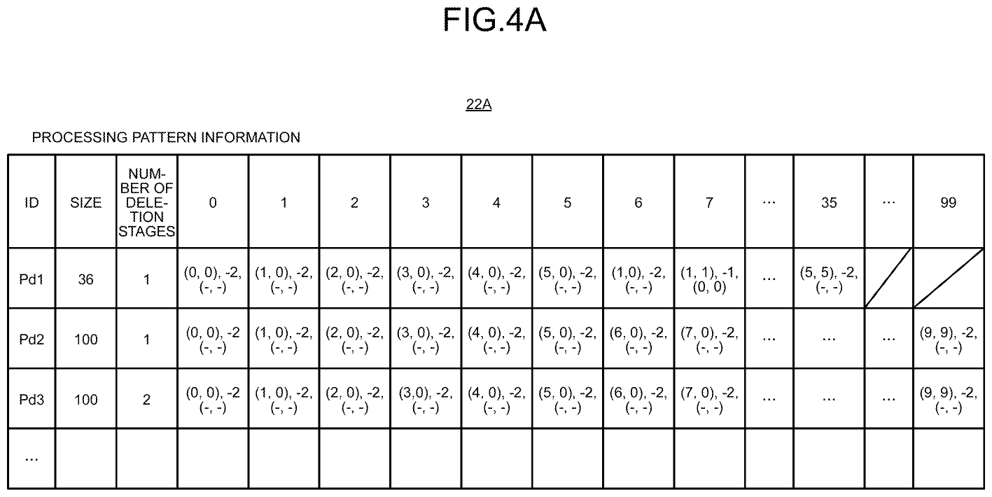

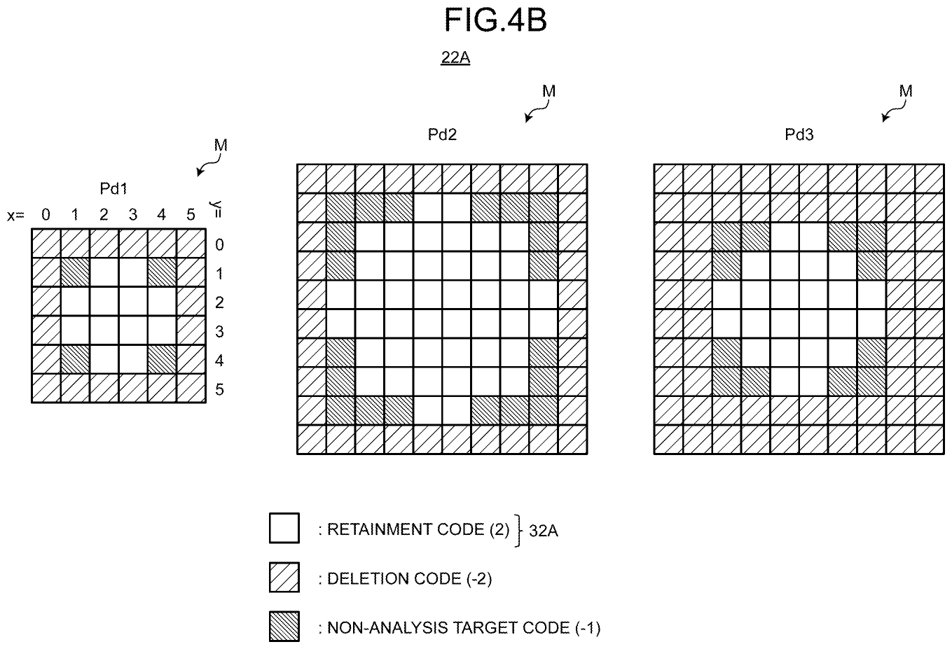

FIGS. 4A and 4B are explanatory diagrams of an example of the processing pattern information 22A. FIG. 4A is a schematic diagram illustrating an example of a data format of each of a plurality of processing patterns Pd. FIG. 4B is an image diagram illustrating each of the processing patterns Pd arranged on the map M.

The processing pattern information 22A is information in which a plurality of different processing patterns Pd of at least a part of the processing rule is registered.

As illustrated in FIG. 4A, the ID of the processing pattern Pd and the data of the data size, the number of deletion stages, and the number of pieces of data of the data size of the processing pattern Pd identified by the corresponding ID are registered in the processing pattern information 22A in association with each other. A plurality of processing patterns Pd that differ in at least one of the data size and the number of deletion stages is registered in the processing pattern information 22A.

In FIG. 4A, ID represents identification information of the processing pattern Pd. FIGS. 4A and 4B illustrate Pd1 to Pd3 as an example of the ID of the processing pattern Pd. Note that tn the processing pattern information 22A, four or more processing patterns Pd may be registered.

The data size indicated in the processing pattern information 22A is the data size of the processing pattern Pd.

The number of deletion stages represents the number of stages in which at least one of deletion of the data value of the analysis target region 30A in the original data Din by the processing pattern Pd and replacement with a code representing the non-analysis target region is performed. The number of deletion stages “1” indicates that the data value of one stage (corresponding to one position coordinate) along the outer periphery of the map M of the original data Din and the data value of one stage (corresponding to one position coordinate) from the outer periphery toward the inside of the analysis target region 30A along the outer periphery of the analysis target region 30A in the original data Din are replaced with a code indicating deletion or non-analysis target. The number of deletion stages “2” indicates that the data values of two stages (corresponding to one position coordinate) along the outer periphery of the map M of the original data Din and the data values of two stages (corresponding to two position coordinates) from the outer periphery toward the inside of the analysis target region 30A along the outer periphery of the analysis target region 30A in the original data Din are replaced with codes indicating deletion or non-analysis target.

Note that the processing pattern information 22A may have a form in which each of the number of stages to be deleted and the number of stages to be replaced with a code representing the non-analysis target region is defined. In the present embodiment, a mode in which the number of deletion stages represents the number of stages for performing at least one of deletion and replacement with a code representing a non-analysis target region will be described as an example.

In FIG. 4A, the numbers 0, 1, 2, 3, 4, 5, 6, 7, . . . assigned along the horizontal axis are numbers assigned to the values included in the processing pattern Pd, and correspond to identification numbers of the values of the position coordinates. m corresponds to the number of pieces of data of values respectively at position coordinates included in the processing pattern Pd, that is, the data size of the processing pattern Pd.

For example, each of the plurality of values constituting the processing pattern Pd is represented by ((x1_j, y1_j), v_j, (x2_j, y2_j)). (x1_j, y1_j) is a position coordinate in the original data Din, and represents an x coordinate and a y coordinate. (x2_j, y2_j) is a position coordinate in the processed data Dout, and represents an x coordinate and a y coordinate. v_j represents a processing rule of the data value of (x1_j, y1_j) of the original data Din.

That is, ((x1_j, y1_j), v_j, (x2_j, y2_j)) means that the data value of the position coordinates (x1_j, y1_j) in the original data Din is processed according to the processing rule v_j and set to the position coordinates (x2_j, y2_j) in the processed data Dout. Although details will be described later, in the present embodiment, the values of (x1_j, y1_j) and (x2_j, y2_j) indicated by the numbers in the processing pattern Pd represent the same position coordinates between the original data Din and the processed data Dout. Therefore, the data value of the position coordinates (x1_j, y1_j) in the original data Din is processed by the processing rule v_j and set to the same position coordinates (x2 j, y2_j) as (x1_j, y1_j) in the processed data Dout.

In the present embodiment, a form in which the processing pattern Pd is a pattern defining any processing rule of a retainment code “2” representing that a data value in the original data Din is to be used as it is, a deletion code “−2” representing that the data value is to be deleted, or a non-analysis target code “−1” representing that the data value is not to be analyzed, for each position coordinate, will be described as an example. That is, in the present embodiment, any of the signs “2”, “−2”, and “−1” is defined in advance in the processing rule v_j.

Therefore, for example, the value ((x1_j, y1_j), v_j=−2, (x2 j, y2 j)) in the processing pattern Pd means that the data value of the position coordinates (x1_j, y1_j) of the original data Din is deleted, and nothing is set in the position coordinates (x2_j, y2_j) in the processed data Dout. Furthermore, ((x1_j, y1_j), v_j=−1, (x2_j, y2_j)) in the processing pattern Pd means that the data value of the position coordinates (x1_j, y1_j) of the original data Din is replaced with a value “−1” representing non-analysis target, and is set to the position coordinates (x2_j, y2_j) in the processed data Dout. Furthermore, ((x1_j, y1_j), v_j=2, (x2_j, y2_j)) in the processing pattern Pd means that the data value of the position coordinates (x1_j, y1_j) of the original data Din is directly set to the position coordinates (x2_j, y2_j) in the processed data Dout.

Note that these data formats are merely examples, and the data format of the processing pattern Pd may be another data format. Furthermore, the codes representing the respective processing rules such as the retainment code, the deletion code, and the non-analysis target code are not limited to “2”, “−2”, and “−1”.

As illustrated in FIG. 4B, in the present embodiment, in the processing pattern Pd, the retainment code “2” is defined at position coordinates in a region having a shape similar to the shape of the analysis target region 30A in the original data Din. Specifically, a region 32A in which the retainment code is defined in the processing pattern Pd has a shape similar to the shape of the analysis target region 30A (see FIG. 3B) in the original data Din.

Furthermore, in the present embodiment, in the processing pattern Pd, the non-analysis target code “−1” or the deletion code “−2” is defined on the outer periphery of the region 32A in which the retainment code “2” is defined.

Therefore, in the present embodiment, a mode in which the processing pattern Pd has a code representing a processing rule determined in advance so as to maintain the shape of the analysis target region 30A included in the original data Din to be processed will be described as an example. Note that the shape of the region 32A in which the setting target code is defined in the processing pattern Pd and the shape of the analysis target region 30A of the original data Din are not limited to similar shapes.

Returning to FIG. 2, the description will be continued.

The specification section 20B specifies one processing pattern Pd corresponding to the group of the plurality of pieces of original data Din acquired by the acquisition section 20A from the processing pattern information 22A.

Specifically, the specification section 20B acquires one or a plurality of processing patterns Pd having a data size matching the data size of the plurality of original data Din acquired by the acquisition section 20A from the processing pattern information 22A. As described above, the acquisition section 20A acquires the plurality of pieces of original data Din having the same data size and the same number of pieces of data in the analysis target region 30A as the plurality of pieces of original data Din to be processed. Therefore, the specification section 20B may measure the data size (the number of pieces of data) of one original data Din among the plurality of pieces of original data Din acquired by the acquisition section 20A. Then, the specification section 20B acquires one or a predetermined number of the plurality of processing patterns Pd having a data size matching the measured data size from the processing pattern information 22A. The specification section 20B specifies arbitrary one piece of processing pattern information 22A as a processing pattern Pd used for processing the original data Din from the acquired one or more processing patterns Pd.

Furthermore, the specification section 20B acquires one or a plurality of processing patterns Pd having a data size matching the data size of the group of the plurality of original data Din acquired by the acquisition section 20A from the processing pattern information 22A. Then, the output control section 20D outputs, to the UI unit 26, a list of the processing patterns Pd having different one or more processing rules acquired by the specification section 20B. For example, a display screen representing the plurality of processing patterns Pd illustrated in FIG. 4B is displayed on the UI unit 26. The user operates the UI unit 26 while visually recognizing the UI unit 26 to select the desired one processing pattern Pd.

The specification section 20B specifies one processing pattern Pd selected by an operation instruction of the UI unit 26 by the user among one or a plurality of processing patterns Pd output to the UI unit 26 as the processing pattern Pd used for processing the plurality of pieces of original data Din.

Furthermore, the specification section 20B acquires information indicating the number of deletion stages from the UI unit 26. For example, the output control section 20D displays a screen prompting the input of the processing parameter on the UI unit 26. The user operates the UI unit 26 to input a value representing a desired number of deletion stages. The specification section 20B acquires information indicating the number of deletion stages from the UI unit 26. Then, the specification section 20B selects, from the processing pattern information 22A, the processing pattern Pd corresponding to the data size of the plurality of pieces of original data Din acquired by the acquisition section 20A and the number of deletion stages acquired from the UI unit 26. The specification section 20B specifies the selected processing pattern Pd as the processing pattern Pd used for processing the original data Din.

Furthermore, the specification section 20B acquires, from the processing pattern information 22A, the processing pattern Pd corresponding to the data sizes of the plurality of pieces of original data Din acquired by the acquisition section 20A and the number of deletion stages acquired from the UI unit 26. Then, the specification section 20B outputs a list of the acquired processing patterns PD to the UI unit 26. Then, the specification section 20B may specify one Pd selected by an operation instruction of the UI unit 26 by the user as the processing pattern Pd used for processing the plurality of pieces of original data Din.

Note that the output control section 20D may further output the processing pattern Pd of 1 specified by the specification section 20B to the UI unit 26 as the processing pattern Pd used for processing the plurality of pieces of original data Din acquired by the acquisition section 20A. Furthermore, when the acquisition section 20A acquires a plurality of pieces of original data Din, the output control section 20D may display the plurality of pieces of acquired original data Din on the UI unit 26. Then, the output control section 20D may display a message prompting the input of the number of deletion stages or a list of the plurality of processing patterns Pd registered in the processing pattern information 22A on the UI unit 26.

Next, the processing section 20C will be described.

The processing section 20C processes the original data Din acquired by the acquisition section 20A using the processing pattern Pd specified by the specification section 20B to generate processed data Dout.

Specifically, for each of the plurality of pieces of original data Din acquired by the acquisition section 20A, the processing section 20C generates the processed data Dout by processing the data value of each position coordinate of the original data Din according to the code representing the processing rule defined in the same position coordinate in the specified processing pattern Pd and sequentially arranging the data value at the position coordinate.

Specifically, for each of the plurality of pieces of original data Din acquired by the acquisition section 20A, the processing section 20C specifies, for each of the included position coordinates (x, y), a value ((x1_j, y1_j), v_j, (x2_j, y2_j)) including the same position coordinates (x1_j, y1_j) as the position coordinates (x, y) in the processing pattern Pd. Then, the processing section 20C processes the data value of the position coordinates (x1_j, y1_j) in the original data Din according to the processing rule represented by v_j included in the specified value, and sets the data value as the position coordinates (x2_j, y2_j) in the processed data Dout.

The processing section 20C performs these processes for each position coordinate in each of the plurality of pieces of original data Din acquired by the acquisition section 20A, thereby generating processed data Dout obtained by processing the original data Din according to the processing pattern Pd.

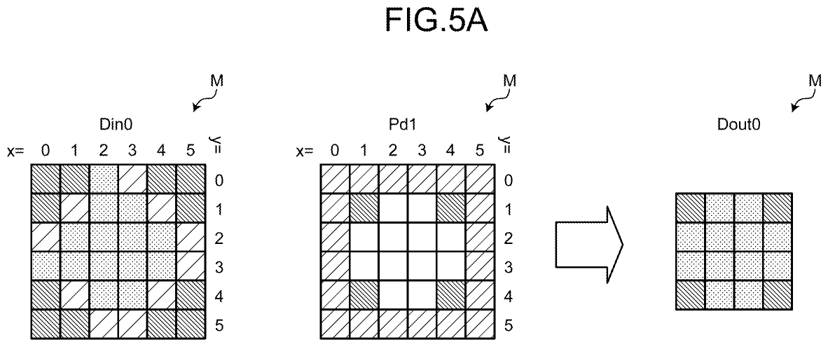

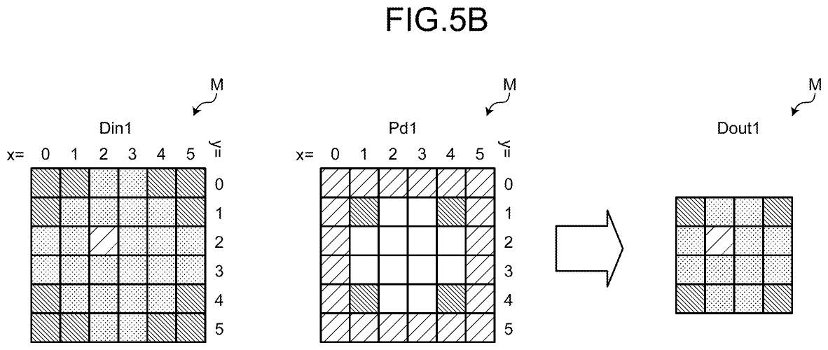

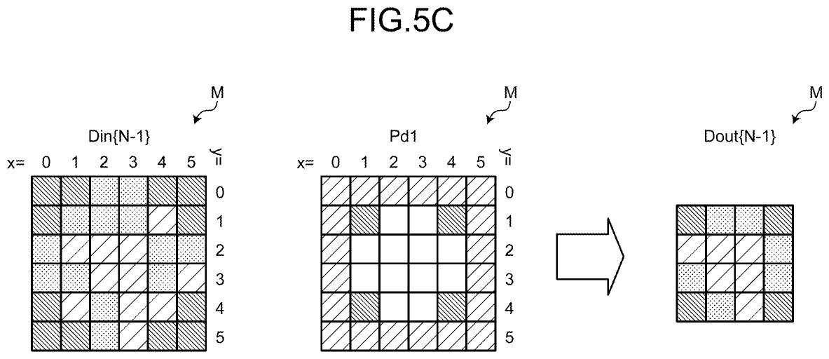

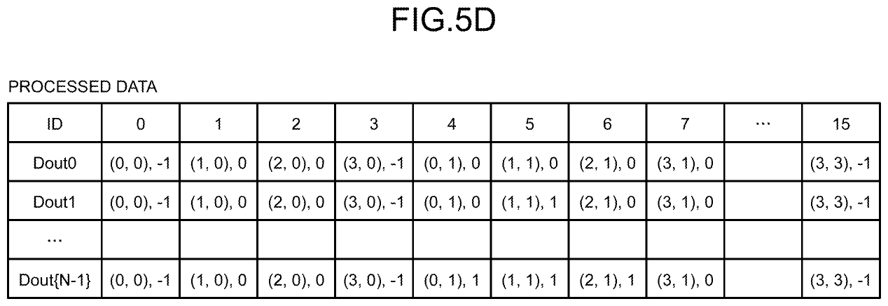

FIGS. 5A to 5D are explanatory diagrams of an example of processing of the original data Din by the processing section 20C.

FIG. 5A is an explanatory diagram of an example of the processing of generating processed data Dout0 by processing the original data Din0 illustrated in FIGS. 3A and 3B using the processing pattern Pd1 illustrated in FIGS. 4A and 4B.

FIG. 5B is an explanatory diagram of an example of the processing of generating processed data Dout1 by processing the original data Din1 illustrated in FIGS. 3A and 3B using the processing pattern Pd1 illustrated in FIGS. 4A and 4B.

FIG. 5C is an explanatory diagram of an example of the processing of generating processed data Dout{N−1} by processing the original data Din{N−1} illustrated in FIGS. 3A and 3B using the processing pattern Pd1 illustrated in FIGS. 4A and 4B.

FIG. 5D is a schematic diagram of an example of a data configuration of each of the processed data Dout0 to the processed data Dout{N−1} generated using the processing pattern Pd for the original data Din0 to the original data Din{N−1}.

As illustrated in FIG. 5D, the processing section 20C processes N pieces of original data Din (original data Din0 to original data Din{N−1}) using the processing pattern Pd, thereby generating N pieces of processed data Dout0 to Dout{N−1}. Each processed data Dout includes m pieces of data corresponding to the identifier ID. Each of the plurality of pieces of data constituting the processed data Dout is represented by ((x, y), v_Din_j) similarly to the original data Din. x represents an x coordinate value, and y represents a y coordinate value. v_Din_j represents a data value defined in the position coordinates (x, y).

When the processing section 20C processes the original data Din using the processing pattern Pd, any one of the same value as the data value in the original data Din and “−1” not to be analyzed is defined in each position coordinate of the processed data Dout. Furthermore, either “0” representing the non-defective product or “1” representing the defective product is defined in the set position coordinates having the same value as the data value in the original data Din. Furthermore, the data of the position coordinates defined by the deletion code “−2” is deleted by the processing pattern Pd in the original data Din, and is not included in the processed data Dout.

As described above, the processing section 20C of the present embodiment generates the processed data Dout by processing the original data Din using the processing pattern Pd. Therefore, the processing section 20C can generate the processed data Dout by the processing of one step using the processing pattern Pd without performing the outer periphery specifying processing of specifying the outer periphery of the analysis target region 30A in the original data Din and the deletion processing of deleting a part of the data value included in the original data Din according to the specified outer periphery stepwise.

Therefore, the processing unit 20 of the present embodiment can reduce the amount of calculation related to data processing for suppressing leakage of confidential information.

The output control section 20D outputs various types of information.

For example, as described above, the output control section 20D displays the plurality of pieces of original data Din acquired by the acquisition section 20A on the UI unit 26. Furthermore, the output control section 20D displays, on the UI unit 26, a list of the processing patterns Pd having different one or more processing rules acquired by the specification section 20B. Furthermore, the output control section 20D may display one processing pattern Pd specified by the specification section 20B on the UI unit 26 as the processing pattern Pd used for processing the plurality of pieces of original data Din acquired by the acquisition section 20A. Furthermore, when the acquisition section 20A acquires a plurality of pieces of original data Din, the output control section 20D may display the plurality of pieces of acquired original data Din on the UI unit 26. Then, the output control section 20D may display a message prompting the input of the number of deletion stages or a list of the plurality of processing patterns Pd registered in the processing pattern information 22A on the UI unit 26.

Furthermore, the output control section 20D may store the processed data Dout processed by the processing section 20C in the storage unit 22. At this time, the output control section 20D may store the information regarding the processing pattern Pd used for processing the processed data Dout and the original data Din of the processing source of the processed data Dout in the storage unit 22 in association with each other. The information regarding the processing pattern Pd is, for example, information such as the processing pattern Pd used for processing the processed data Dout, the data size and the number of deletion stages used for specifying the processing pattern Pd, and the like.

Furthermore, the output control section 20D may transmit the processed data Dout processed by the processing section 20C to the analysis apparatus 12 identified by a predetermined destination via the communication unit 24. The predetermined destination may be input by, for example, an operation of the UI unit 26 by the user. Furthermore, the predetermined destination may be stored in the storage unit 22 in advance.

Furthermore, the output control section 20D may transmit the processed data Dout stored in the storage unit 22 to the analysis apparatus 12 of a predetermined destination when an instruction to transmit the processed data Dout to the analysis apparatus 12 is input according to an operation instruction to the UI unit 26 by the user.

Next, an example of a flow of information processing executed by the information processing apparatus 10 according to the present embodiment will be described.

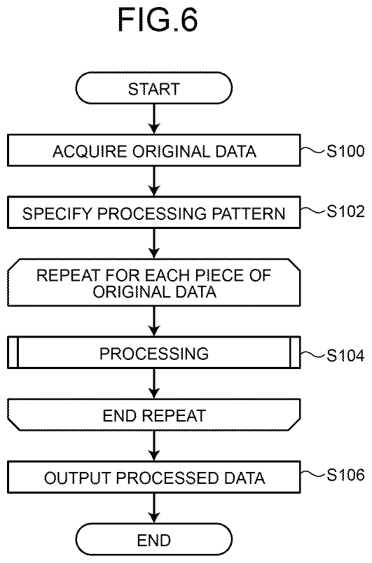

FIG. 6 is a flowchart illustrating an example of a flow of information processing executed by the information processing apparatus 10 according to the present embodiment.

The acquisition section 20A acquires a plurality of pieces of original data Din to be processed (step S100).

The specification section 20B specifies one processing pattern Pd corresponding to the original data Din acquired in step S100 from the processing pattern information 22A stored in the storage unit 22 (step S102).

As described above, the specification section 20B measures the data size of the original data Din acquired in step S100, for example. Furthermore, the specification section 20B acquires information indicating the number of deletion stages from the UI unit 26. Then, the specification section 20B acquires the processing pattern Pd corresponding to the measured data size and the acquired number of deletion stages from the processing pattern information 22A. The specification section 20B outputs a list of the acquired processing patterns PD to the UI unit 26, and specifies one Pd selected by an operation instruction of the UI unit 26 by the user as the processing pattern Pd used for processing the plurality of pieces of original data Din. Note that, in a case where the processing pattern Pd corresponding to the measured data size and the acquired number of deletion stages is not registered in the processing pattern information 22A, the specification section 20B may output error information to the UI unit 26 and end the processing.

Next, the processing section 20C executes the processing in step S104 for each of the plurality of original data Din acquired in step S100.

For example, the processing section 20C reads one piece of original data Din to be processed from the group of the plurality of pieces of original data Din acquired in step S100, and deletes the read original data Din from the group. Then, every time one piece of original data Din is read, the processing section 20C executes the processing in step S104 on the read original data Din. Then, the processing section 20C executes the processing in step S104 for each of the plurality of pieces of original data Din acquired in step S100 by executing the repetitive processing until there is no original data Din in the group.

Details of the processing by the processing section 20C will be described later.

The output control section 20D outputs a plurality of pieces of the processed data Dout generated by the processing in step S104 (step S106). For example, the output control section 20D outputs the plurality of processed data Dout to at least one of the storage unit 22, the UI unit 26, and the analysis apparatus 12. Then, this routine is ended.

Next, a detailed flow of the processing (step S104 in FIG. 6) executed by the processing section 20C will be described.

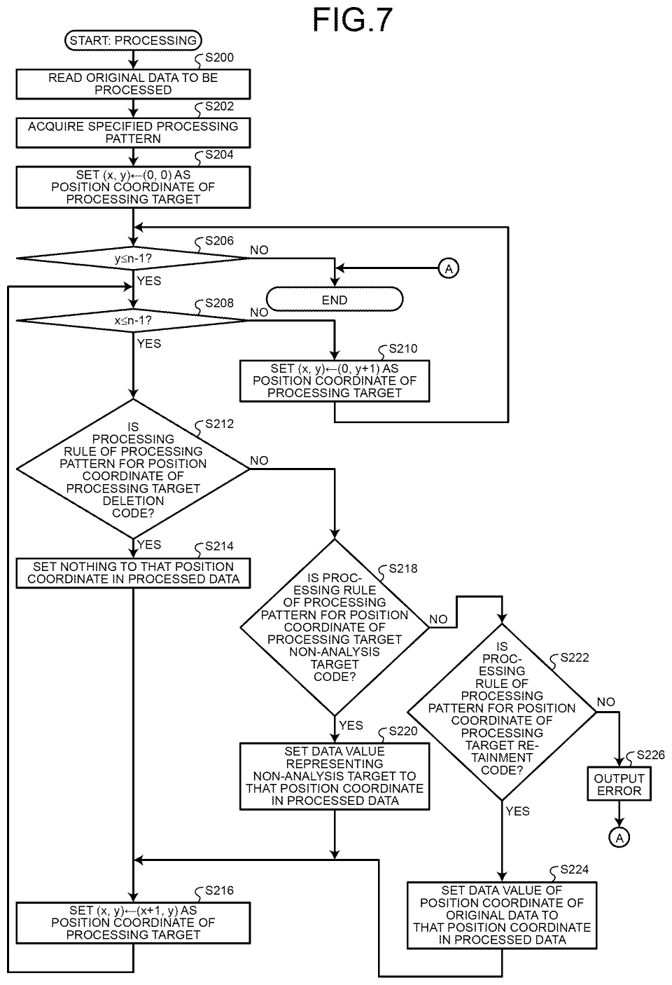

FIG. 7 is a flowchart illustrating an example of a flow of processing executed by the processing section 20C. The flowchart of FIG. 7 is a flowchart illustrating details of the processing in step S104 of FIG. 6.

The processing section 20C reads one piece of original data Din unprocessed by the processing process among the plurality of pieces of original data Din acquired by the acquisition section 20A in step S100 of FIG. 5 (step S200). Furthermore, the processing section 20C acquires the processing pattern Pd specified by the specification section 20B (step S202).

Then, the processing section 20C sets the initial value (0, 0) as the position coordinates (x, y) of the processing target in the original data Din read in step S200 (step S204).

The processing section 20C determines whether or not the value of y in the position coordinates of the processing target is n−1 or less (step S206). As described above, n is the number of pieces of data of the data value included in the original data Din. Therefore, the processing section 20C determines whether or not the processing has been completed up to the data of the last position coordinate in the y-axis direction in the original data Din read in step S200 according to the determination in step S206. When a negative determination is made in step S206 (step S206: No), this routine is ended. When an affirmative determination is made in step S206 (step S206: Yes), the process proceeds to step S208.

Next, the processing section 20C determines whether or not the value of x in the position coordinates of the processing target is n−1 or less (step S208). As described above, n is the number of pieces of data of the data value included in the original data Din. Therefore, the processing section 20C determines whether or not the processing has been completed up to the data of the last position coordinate in the x-axis direction in the original data Din read in step S200 according to the determination in step S208.

When a negative determination is made in step S208 (step S208: No), the process proceeds to step S210. In step S210, the processing section 20C sets (0, y+1) to the position coordinates (x, y) of the processing target, initializes the position in the x-axis direction, which is the position coordinates of the processing target, to 0, and counts up the position in the y-axis direction by one (step S210). The process returns to step S206 described above.

When an affirmative determination is made in step S208 (step S208: Yes), the process proceeds to step S212.

In step S212, the processing section 20C determines whether or not the processing rule of the processing pattern Pd for the position coordinates (x, y) of the processing target is a deletion code (step S212). Specifically, with respect to the position coordinates (x, y) of the processing target, the processing section 20C specifies a value ((x1_j, y1_j), v_j, (x2 j, y2 j)) including the same position coordinates (x1_j, y1_j) as the position coordinates (x, y) in the processing pattern Pd acquired in step S202. Then, the processing section 20C determines whether or not the processing rule represented by the specified v_j is the deletion code “−2”.

In a case of determining that the position coordinate is the deletion code “−2” (step S212: Yes), the processing section 20C sets nothing to the same position coordinate (x2_j, y2_j) as the position coordinate (x, y) in the processed data Dout (step S214). Therefore, in the original data Din, the data value of the position coordinate in which the deletion code is specified in the processing pattern Pd is not included in the processed data Dout and is deleted.

Next, the processing section 20C sets (x+1, y) to the position coordinates (x, y) of the processing target, counts up the position in the x-axis direction, which is the position coordinates of the processing target, by one (step S216), and returns to step S208 described above.

On the other hand, when a negative determination is made in step S212 (step S212: No), the process proceeds to step S218.

In step S218, the processing section 20C determines whether or not the processing rule of the processing pattern Pd for the position coordinates (x, y) of the processing target is a non-analysis target code (step S218). Specifically, with respect to the position coordinates (x, y) of the processing target, the processing section 20C specifies a value ((x1_j, y1_j), v_j, (x2_j, y2_j)) including the same position coordinates (x1_j, y1_j) as the position coordinates (x, y) in the processing pattern Pd acquired in step S202. Then, the processing section 20C determines whether or not the processing rule represented by the specified v_j is the non-analysis target code “−1”.

In a case where the non-analysis target code is determined to be “−1” (step S218: Yes), the processing section 20C sets a data value “−1” representing non-analysis target at the same position coordinates (x2_j, y2_j) as the position coordinates (x, y) in the processed data Dout (step S220). Therefore, in the original data Din, the data value of the position coordinates at which the non-analysis target code is specified in the processing pattern Pd is processed into “−1” and set at the position coordinates of the processed data Dout. Then, the process proceeds to step S216 described above.

On the other hand, when a negative determination is made in step S218 (step S218: No), the process proceeds to step S222.

In step S222, the processing section 20C determines whether or not the processing rule of the processing pattern Pd for the position coordinates (x, y) of the processing target is the retainment code (step S222). Specifically, with respect to the position coordinates (x, y) of the processing target, the processing section 20C specifies a value ((x1_j, y1_j), v_j, (x2 j, y2_j)) including the same position coordinates (x1_j, y1_j) as the position coordinates (x, y) in the processing pattern Pd acquired in step S202. Then, the processing section 20C determines whether or not the processing rule represented by the specified v_j is the retainment code “2”.

In a case where it is determined that the retainment code is “2” (step S222: Yes), the processing section 20C sets the data value defined in the position coordinates (x, y) in the original data Din at the same position coordinates (x2 j, y2 j) as the position coordinates (x, y) in the processed data Dout (step S224). Therefore, the data value of the position coordinates defined by the retainment code in the processing pattern Pd in the original data Din is set to the position coordinates of the processed data Dout while maintaining the value as it is. Then, the process proceeds to step S216 described above.

On the other hand, in a case where the determination in step S222 is negative (step S222: No), the processing section 20C outputs an error to the UI unit 26 via the output control section 20D, and ends this routine without generating the processed data Dout.

As described above, the information processing apparatus 10 of the present embodiment includes the processing section 20C. The processing section 20C generates processed data Dout obtained by processing the original data Din using the processing pattern Pd that defines, for each position coordinate on the map M, a processing rule of the original data Din including a group of a plurality of data values arranged respectively at position coordinates along a predetermined direction on the map M.

Furthermore, the information processing method of the present embodiment is an information processing method executed by a computer, and includes a processing step of generating processed data Dout obtained by processing original data Din by using a processing pattern Pd in which a processing rule of the original data Din including a group of a plurality of data values arranged respectively at position coordinates along a predetermined direction on a map M is defined for each position coordinate on the map M.

As described above, the processing section 20C of the present embodiment generates the processed data Dout by processing the original data Din using the processing pattern Pd. Therefore, the processing section 20C can generate the processed data Dout by the processing of one step using the processing pattern Pd without performing the outer periphery specifying processing of specifying the outer periphery of the analysis target region 30A in the original data Din and the deletion processing of deleting a part of the data value included in the original data Din according to the specified outer periphery stepwise.

Therefore, the information processing apparatus 10 and the information processing method of the present embodiment can reduce an amount of calculation regarding data processing for suppressing confidential leakage. Furthermore, the information processing program for causing a computer to execute information processing in the information processing apparatus 10 can reduce the amount of calculation regarding data processing for suppressing confidential leakage, similarly to the information processing apparatus 10 and the information processing method.

Therefore, the information processing apparatus 10, the information processing method, and the information processing program of the present embodiment can reduce the amount of calculation related to data processing for suppressing confidential leakage.

Furthermore, in the present embodiment, in the processing pattern Pd, the retainment code “2” is defined at the position coordinates in a region having a shape similar to the shape of the analysis target region 30A in the original data Din (see FIG. 4B). Specifically, a region 32A in which the retainment code is defined in the processing pattern Pd has a shape similar to the shape of the analysis target region 30A (see FIG. 3B) in the original data Din.

Therefore, in the present embodiment, it is possible to make it impossible to specify the deleted portion deleted by the processing section 20C at the time of analysis using the processed data Dout by the analysis apparatus 12. Therefore, in addition to the above effects, the information processing apparatus 10 of the present embodiment can generate the processed data Dout in which it is difficult to estimate the original data Din.

Furthermore, the information processing apparatus 10 according to the present embodiment generates processed data Dout obtained by processing the original data Din according to the processing rule represented by the processing pattern Pd. For example, as described above, the processing rule is any of the retainment code “2” indicating that the data value in the original data Din is to be used as it is, the deletion code “−2” indicating that it is a deletion target, or the non-analysis target code “−1” indicating that it is not an analysis target. Therefore, the processing section 20C can generate the processed data Dout obtained by processing the original data Din by condition comparison the number of times (3 times in the above embodiment) according to the type of processing rule. Therefore, the information processing apparatus 10 of the present embodiment can reduce the number of times of condition comparison at the time of processing as compared with the conventional processing method.

Note that, in the above embodiment, the description has been given assuming a case where any of “0” indicating a non-defective product, “1” indicating a defective product, and “−1” indicating not to be analyzed is defined as the data value v_Din_j of the original data Din. Furthermore, in the above embodiment, the case where the processing rule is any of the retainment code “2” indicating that the data value in the original data Din is to be used as it is, the deletion code “−2” indicating that the original data Din is to be deleted, or the non-analysis target code “−1” indicating that the original data Din is not to be analyzed has been described as an example. However, the type of the code representing the processing rule is not limited thereto. For example, the number of times of the condition comparison can be further reduced by adjusting the type of the data value and the type of the code representing the processing rule.

For example, it is assumed that any of “1” indicating a non-defective product, “−1” indicating a defective product, and “0” indicating not to be analyzed is defined as the data value v_Din_j of the original data Din. Furthermore, it is assumed that the processing rule is any of a retainment code “1” indicating that the data value in the original data Din is to be used as it is, a deletion code “2” indicating that the data value is to be deleted, or a non-analysis target code “0” indicating that the data value is not to be analyzed.

In this case, instead of the processing of steps S212 to S226, the following processing may be executed. Specifically, assuming that v_Din_j×v_j=v_tmp_j, the processing section 20C adds 1 to x when v_j=2, and returns to step S208. In a case where v_j=2 is not satisfied, v_tmp_j may be set as a data value at the same position coordinates (x2_j, y2_j) as the position coordinates (x, y) in the processed data Dout, 1 may be added to x, and the process may return to step S208.

Note that v_j represents a data processing rule corresponding to the data value v_Din_j of the original data Din. When v_j is the retainment code “1”, v_tmp_j has the same value as v_Din_j and data is maintained. When v_j is the non-analysis target code “0”, v_tmp_j becomes “0” representing non-analysis target. When v_j is the deletion code “2” representing that v_j is the deletion target, the value of v_tmp_j is deleted from the processed data Dout.

By adjusting the type of the data value and the type of the code representing the processing rule as described above, the processing section 20C can generate the processed data Dout by performing one condition comparison for data of one position coordinate in the original data Din.

Modified example 1 In the above embodiment, the form in which the map M is a two-dimensional map arranged in a two-dimensional space has been described as an example. Therefore, in the above embodiment, a mode in which the predetermined direction that is the arrangement direction of the data values on the map M is the K-dimensional direction (K=2 in the present embodiment) including a first direction on the map and a second direction intersecting the first direction has been described as an example. The description has been given assuming that the first direction is the x-axis direction and the second direction is the y-axis direction orthogonal to the x-axis direction.

However, the map M may be a one-dimensional map. That is, the predetermined direction that is an arrangement direction of the data values on the map M may be a one-dimensional direction on the map. Specifically, the arrangement direction of the data values in the map M may be, for example, the x-axis direction along the one-dimensional direction of the map M.

In this case, the data value included in the original data Din is arranged for each position coordinate represented by the x coordinate along the x-axis direction of the map M represented by the one-dimensional space. Furthermore, the processing pattern Pd may also be represented by a one-dimensional space.

The processing unit 20 of the information processing apparatus 10 generates the processed data Dout from the original data Din in the same manner as in the above embodiment except that the position coordinate represented by the x coordinate is used instead of the position coordinate represented by the x coordinate and the y coordinate in the above embodiment.

Also in a case where the information processing apparatus 10 uses the one-dimensional original data Din and the processing pattern Pd, the same effects as those of the above embodiment can be obtained.

Furthermore, in the present modified example, since the position coordinate represented by the x coordinate is used, the amount of calculation regarding data processing can be further reduced as compared with the case of using the position coordinate represented by the x coordinate and the y coordinate.

### Second Embodiment

In the embodiment described above, the processed data Dout is generated by processing the original data Din using the processing pattern Pd. In the present embodiment, a mode will be described in which shuffled data obtained by replacing position coordinates of data values of the original data Din with other position coordinates in the analysis target region 30A is processed using the processing pattern Pd to generate the processed data Dout.

Note that, in the present embodiment, the same reference signs as those in the above embodiment are assigned to the same configurations as those in the above embodiment, and a detailed description thereof will be omitted.

FIG. 1 is a schematic diagram illustrating an example of an information processing system 1B according to the present embodiment. The information processing system 1B is similar to the information processing system 1 of the above embodiment except that an information processing apparatus 10B is provided instead of the information processing apparatus 10.

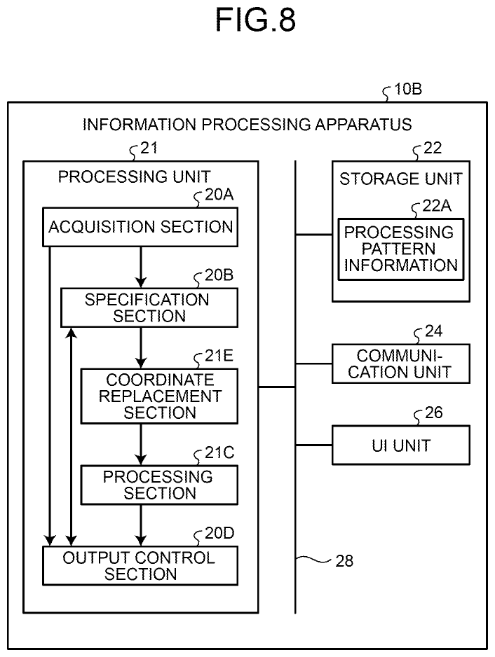

FIG. 8 is a block diagram illustrating an example of a functional configuration of the information processing apparatus 10B.

The information processing apparatus 10B includes a processing unit 21, a storage unit 22, a communication unit 24, and a UI unit 26. The information processing apparatus 10B has the same configuration as the information processing apparatus 10 of the above embodiment except that a processing unit 21 is included instead of the processing unit 20.

The processing unit 21 includes an acquisition section 20A, a specification section 20B, a processing section 21C, an output control section 20D, and a coordinate replacement section 21E. The processing unit 21 is similar to the processing unit 20 of the above embodiment except that the coordinate replacement section 21E is further included and the processing section 21C is included instead of the processing section 20C.

The coordinate replacement section 21E performs a coordinate replacement process. The coordinate replacement process is a process of replacing position coordinates of at least some data values of a plurality of data values in the analysis target region 30A in the original data Din with other position coordinates in the analysis target region 30A. In other words, the coordinate replacement process is a process of replacing at least some position coordinates with other position coordinates by shuffling the data of the analysis target region 30A in the original data Din in the analysis target region 30A. The analysis target region 30A in the original data Din or the post-addition original data Din1 in which the data value is added to the addition process to the original data Din is a region of the specified position coordinates of “0” representing the non-defective product or “1” representing the defective product as the data value v_Din1_j that is the state value.

The coordinate replacement section 21E performs the coordinate replacement process on the original data Din using a replacement function Rp.

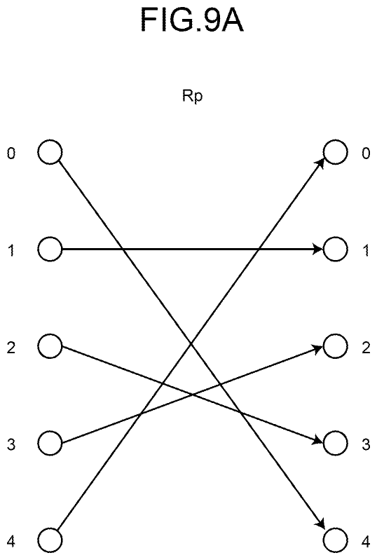

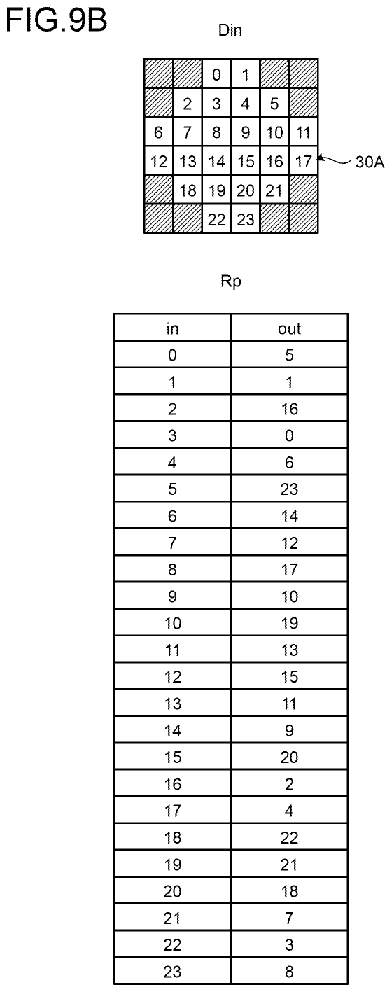

FIG. 9A is an explanatory diagram of an example of the replacement function Rp.

The replacement function Rp is, for example, a function representing a surjective and injective mapping. For example, the replacement function Rp is represented by {0, . . . , nv−1}→{0, . . . , nv−1}. nv is the number of pieces of data in the analysis target region 30A in the original data Din. The replacement function Rp is, for example, a random function or random permutation.

As illustrated in FIG. 9A, for example, the replacement function Rp is a function for replacing each position coordinate of, for example, 0 to 4 in which the data value is defined with another position coordinate. Note that the replacement function Rp may be a function representing pseudo-random replacement. In the present embodiment, a form in which the replacement function Rp is a function representing a surjective and injective mapping will be described as an example.

FIG. 9B is an explanatory diagram of an example of position coordinates before and after replacement by the original data Din and the replacement function Rp. For example, it is assumed that a number of 0 to 23 is assigned to each position coordinate in the analysis target region 30A included in the original data Din. Then, as illustrated in FIG. 9B, it is assumed that the replacement function Rp is a function for replacing the number of position coordinates represented in the field of “in” in the replacement function Rp with the number of position coordinates represented in the field of “out” in the replacement function Rp. In this case, the coordinate replacement section 21E performs the coordinate replacement process on the original data Din using the replacement function Rp, so that the data value defined in the position coordinates of the number represented in the field of “in” in the analysis target region 30A of the original data Din is shuffled to become the data value of the position coordinates of the number represented in the corresponding field of “out”.

The coordinate replacement section 21E specifies the analysis target region 30A by specifying the data value of each position coordinate of the original data Din. For example, for each position coordinate of the original data Din, the coordinate replacement section 21E specifies, as the analysis target region 30A, a region at a position coordinate in which “0” indicating a non-defective product or “1” indicating a defective product is set as a data value representing the analysis target region 30A.

Then, the coordinate replacement section 21E calculates the number of pieces of data nv in the analysis target region 30A in the original data Din.

Note that it is assumed that the data sizes of the plurality of pieces of original data Din acquired by the acquisition section 20A and the number of pieces of data constituting the analysis target region 30A are the same. Therefore, the coordinate replacement section 21E may calculate the number of pieces of data nv constituting the analysis target region 30A and the analysis target region 30A for one original data Din among the plurality of pieces of original data Din acquired by the acquisition section 20A.

Next, the coordinate replacement section 21E selects one replacement function Rp to be used for the plurality of pieces of original data Din acquired by the acquisition section 20A. For example, the coordinate replacement section 21E randomly selects the replacement function Rp from a set of permutation functions represented by {0, . . . , nv−1}→{0, . . . , nv−1} using the number of pieces of data nv constituting the analysis target region 30A.

Then, the coordinate replacement section 21E performs the coordinate replacement process for each piece of original data Din for the plurality of pieces of original data Din acquired by the acquisition section 20A.

Specifically, the coordinate replacement section 21E selects one position coordinate having not been subjected to coordinate replacement in the analysis target region 30A in the original data Din. Then, the coordinate replacement section 21E sets the data value of the selected position coordinate in the original data Din to the position coordinate after replacement obtained by replacing the position coordinate with the replacement function Rp. The coordinate replacement section 21E performs these processes for all position coordinates in the analysis target region 30A in the original data Din, thereby generating the shuffled data Din_shuffled.

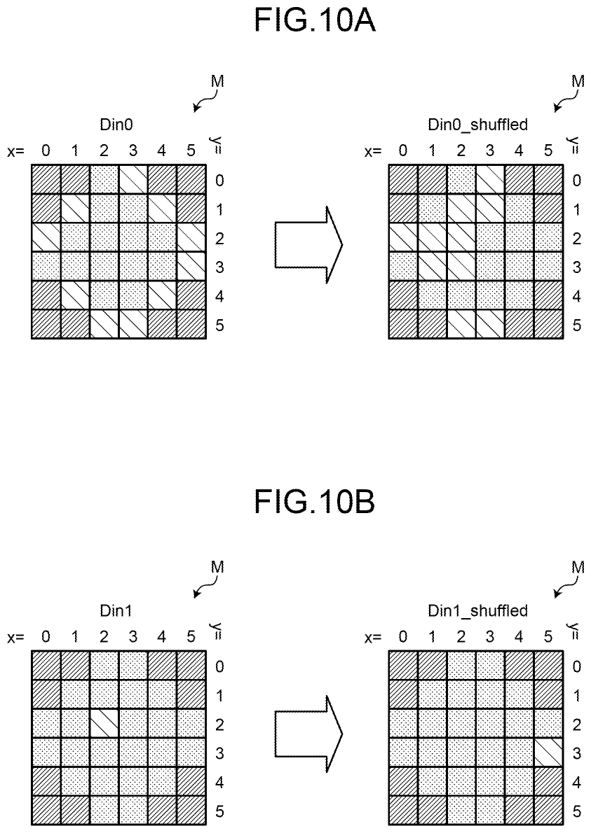

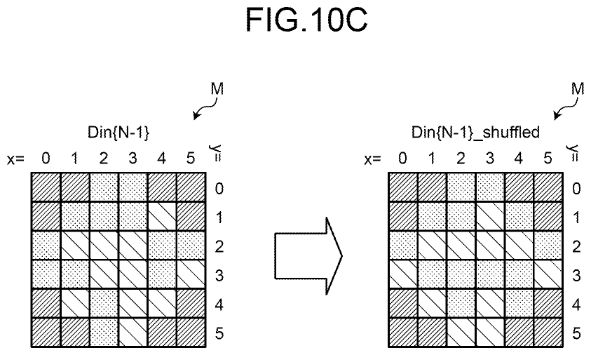

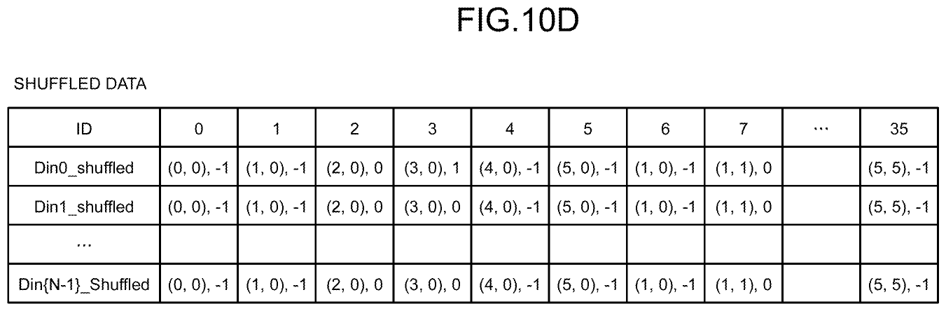

FIGS. 10A to 10D are explanatory diagrams of an example of the coordinate replacement process by the coordinate replacement section 21E.

FIG. 10A is an explanatory diagram of an example of the coordinate replacement process of generating the shuffled data Din0 shuffled by replacing coordinates of the original data Din0 illustrated in FIGS. 3A and 3B by using the replacement function Rp illustrated in FIG. 9B.

FIG. 10B is an explanatory diagram of an example of the coordinate replacement process of generating the shuffled data Din1 shuffled by performing coordinate replacement on the original data Din1 illustrated in FIGS. 3A and 3B using the replacement function Rp illustrated in FIG. 9B.

FIG. 10B is an explanatory diagram of an example of the coordinate replacement process of generating the shuffled data Din{N−1} shuffled by performing coordinate replacement on the original data Din{N−1} illustrated in FIGS. 3A and 3B using the replacement function Rp illustrated in FIG. 9B.

FIG. 10D is a schematic diagram of an example of a data configuration of each of the shuffled data Din0 shuffled to Din{N−1}_shuffled generated using the replacement function Rp for the original data Din0 to the original data Din{N−1}.

As illustrated in FIG. 10D, the coordinate replacement section 21E processes N pieces of original data Din (original data Din0 to original data Din{N−1}) using the same replacement function Rp, so that N pieces of shuffled data Din0 shuffled to Din{N−1}_shuffled are generated. Each shuffled data Din_shuffled includes Num pieces of data corresponding to the identifier ID. Each of the plurality of pieces of data constituting the shuffled data Din_shuffled is represented by ((x, y), v_Din_j) similarly to the original data Din. x represents an x coordinate value, and y represents a y coordinate value. v_Din_j represents a data value defined in the position coordinates (x, y).

As described above, the coordinate replacement section 21E shuffles the position coordinates of the data value in the analysis target region 30A in the original data Din using the replacement function Rp, thereby generating the shuffled data Din_shuffled.

The coordinate replacement section 21E outputs the generated shuffled data Din_shuffled to the processing section 21C.

The processing section 21C generates the processed data Dout in the same manner as in the above embodiment except that the shuffled data Din_shuffled received from the coordinate replacement section 21E is processed using the processing pattern Pd instead of the original data Din.

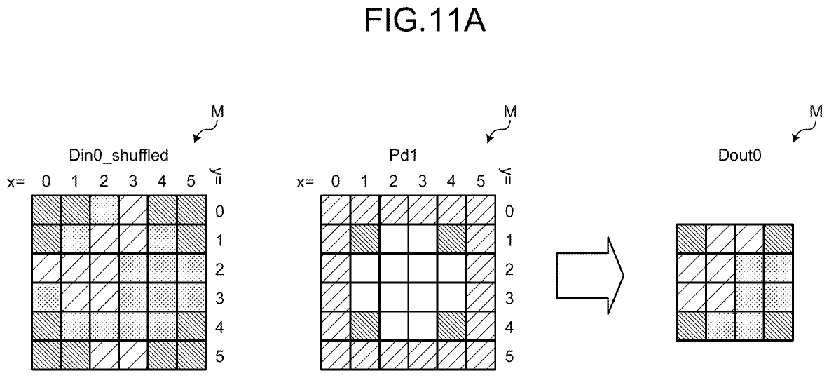

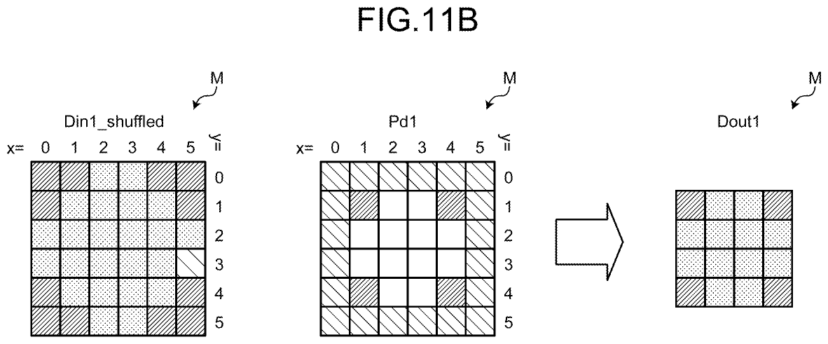

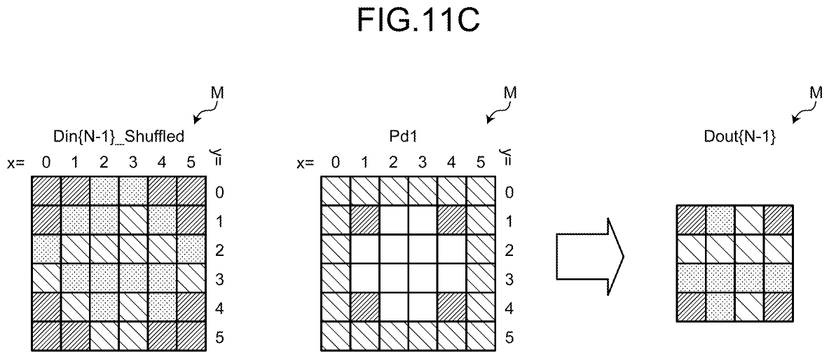

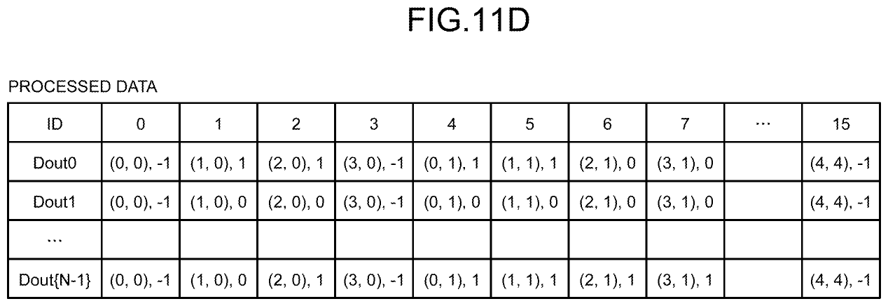

FIGS. 11A to 11D are explanatory diagrams of an example of processing of the shuffled data Din_shuffled by the processing section 20C.

FIG. 11A is an explanatory diagram of an example of the processing of generating the processed data Dout0 by processing the shuffled data Din0_shuffled illustrated in FIG. 10A using the processing pattern Pd1 illustrated in FIGS. 4A and 4B.

FIG. 11A is an explanatory diagram of an example of the processing of generating the processed data Dout1 by processing the shuffled data Din1_shuffled illustrated in FIG. 10B using the processing pattern Pd1 illustrated in FIGS. 4A and 4B.

FIG. 11C is an explanatory diagram of an example of the processing of generating the processed data Dout{N−1} by processing the shuffled data Din{N−1} shuffled illustrated in FIG. 10C using the processing pattern Pd1 illustrated in FIGS. 4A and 4B.

FIG. 11D is a schematic diagram of an example of a data configuration of each of the processed data Dout0 to the processed data Dout{N−1} generated using the processing pattern Pd for the shuffled data Din0_shuffled to the shuffled data Din{N−1}_shuffled.

As illustrated in FIG. 11D, the processing section 21C processes N pieces of shuffled data Din0 shuffled to Din{N−1}_shuffled using the processing pattern Pd, thereby generating N pieces of processed data Dout0 to Dout{N−1}. Each processed data Dout includes an identifier ID and m pieces of data. Each of the plurality of pieces of data constituting the processed data Dout is represented by ((x, y), v_Din_j) similarly to the original data Din. x represents an x coordinate value, and y represents a y coordinate value. v_Din_j represents a data value defined in the position coordinates (x, y).

As the shuffled data Din_shuffled generated from the original data Din is processed by the processing section 21C using the processing pattern Pd, any data value of the same value as the data value in the shuffled data Din_shuffled or “−1” not to be analyzed is defined in each position coordinate of the processed data Dout.

Furthermore, either “₀” representing the non-defective product or “1” representing the defective product is defined at the set position coordinates having the same value as the data value in the shuffled data Din_shuffled. Furthermore, the data of the position coordinates defined by the deletion code “−2” is deleted by the processing pattern Pd in the shuffled data Din_shuffled, and is not included in the processed data Dout.

As described above, the processing section 21C of the present embodiment uses the processing pattern Pd to perform the shuffled process on the shuffled data Din_shuffled generated from the original data Din, thereby generating the processed data Dout. Therefore, the processing section 21C can generate the processed data Dout by the processing of one step using the processing pattern Pd without performing the outer periphery specifying processing of specifying the outer periphery of the analysis target region 30A in the original data Din and the deletion processing of deleting a part of the data value included in the original data Din according to the specified outer periphery stepwise. Furthermore, in the processing unit 21 of the present embodiment, since the shuffled data Din_shuffled generated from the original data Din is used for the processing, the processed data Dout with further improved secrecy and confidentiality can be generated.

Note that the coordinate replacement section 21E may perform the coordinate replacement process after converting the original data Din into one-dimensional data, and output the shuffled data Din_shuffled, which is one-dimensional data, to the processing section 21C. In this case, for example, the processing section 21C may convert the shuffled data Din_shuffled, which is one-dimensional data, into two-dimensional data and then perform the processing.

Furthermore, the coordinate replacement section 21E may perform the coordinate replacement process while keeping the original data Din as two-dimensional data without converting the original data Din into one-dimensional data, and output the shuffled data Din_shuffled which is two-dimensional data to the processing section 21C.

Furthermore, the coordinate replacement section 21E may perform the coordinate replacement process after converting the original data Din into one-dimensional data, convert the shuffled data Din_shuffled, which is one-dimensional data, into two-dimensional data, and output the two-dimensional data to the processing section 21C.

Next, an example of a flow of information processing executed by the information processing apparatus 10B according to the present embodiment will be described.

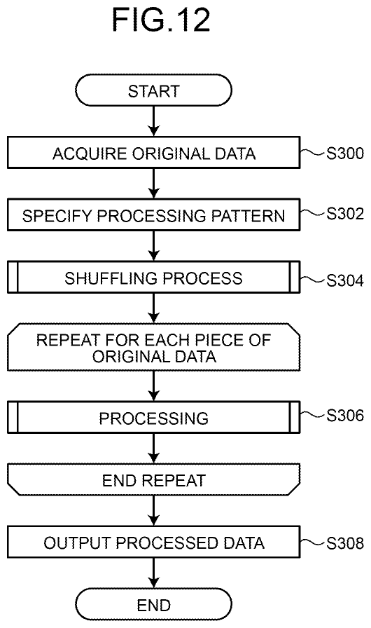

FIG. 12 is a flowchart illustrating an example of a flow of information processing executed by the information processing apparatus 10B according to the present embodiment.

The acquisition section 20A acquires a plurality of pieces of original data Din to be processed (step S300). The specification section 20B specifies one processing pattern Pd corresponding to the original data Din acquired in step S300 from the processing pattern information 22A stored in the storage unit 22 (step S302). The processing in steps S300 and S302 is similar to that in steps S100 and S102 in the above embodiment (see FIG. 6).

Next, the coordinate replacement section 21E performs the shuffling process on the plurality of pieces of original data Din acquired in step S300 (step S304). Details of the shuffling process will be described later. A plurality of pieces of shuffled data Din_shuffled corresponding to each of the plurality of pieces of original data Din is generated by the processing in step S304.

Next, the processing section 21C executes processing for each one piece of shuffled data Din_shuffled on the plurality of pieces of shuffled data Din_shuffled generated in step S304 (step S306). The processing of step S306 is similar to step S104 (see FIG. 6) of the above embodiment except that the shuffled data Din_shuffled is used instead of the original data Din.

Then, the output control section 20D outputs the plurality of processed data Dout generated by the processing in step S306 (step S308). For example, the output control section 20D outputs the plurality of processed data Dout to at least one of the storage unit 22, the UI unit 26, and the analysis apparatus 12. Then, this routine is ended.

Note that, as described above, the processing of step S306 is similar to step S104 (See steps S200 to S226 in FIGS. 6 and 7.) of the above embodiment except that the shuffled data Din_shuffled is used instead of the original data Din.

The present embodiment has been described assuming a case where any of “0” indicating a non-defective product, “1” indicating a defective product, and “−1” indicating not to be analyzed is defined as the data value v_Din_j of the shuffled data Din_shuffled, similarly to the above embodiment. Furthermore, in the present embodiment, the case where the processing rule is any one of the retainment code “2”, the deletion code “−2”, and the non-analysis target code “−1” has been described as an example. However, the type of the code representing the processing rule is not limited thereto. Similarly to the above embodiment, for example, by adjusting the type of the data value and the type of the code representing the processing rule, the number of times of the condition comparison can be further reduced.

For example, it is assumed that any of “1” indicating a non-defective product, “−1” indicating a defective product, and “0” indicating not to be analyzed is defined as the data value v_Din_j of the shuffled data Din_shuffled. Furthermore, it is assumed that the processing rule is any of the retainment code “1” indicating that the data value in the shuffled data Din_shuffled is to be used as it is, the deletion code “2” indicating that the data value is to be deleted, or the non-analysis target code “0” indicating that the data value is not to be analyzed.

In this case, instead of the processing of steps S212 to S226, the following processing may be executed. Specifically, assuming that v_Din_j×v_j=v_tmp_j, the processing section 21C adds 1 to x when v_j=2, and returns to step S208. In a case where v_j=2 is not satisfied, v_tmp_j may be set as a data value at the same position coordinates (x2_j, y2_j) as the position coordinates (x, y) in the processed data Dout, 1 may be added to x, and the process may return to step S208.

Next, a detailed flow of the shuffling process (step S304 in FIG. 12) executed by the coordinate replacement section 21E will be described.

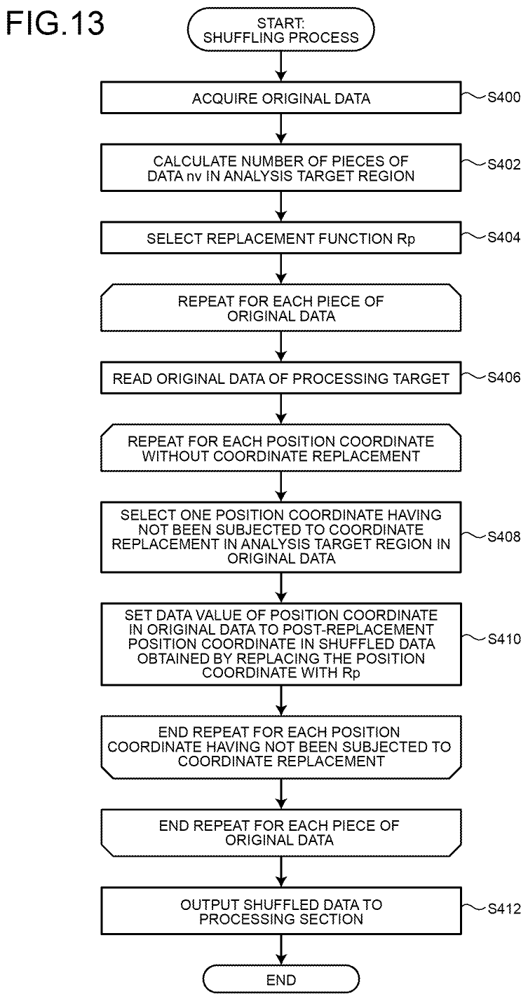

FIG. 13 is a flowchart illustrating an example of a flow of the shuffling process executed by the coordinate replacement section 21E. The flowchart of FIG. 13 is a flowchart illustrating details of the shuffling process in step S304 of FIG. 12.

The coordinate replacement section 21E acquires a plurality of pieces of original data Din acquired by the acquisition section 20A in step S300 (see FIG. 12) (step S400).

Then, the coordinate replacement section 21E calculates the number of pieces of data nv in the analysis target region 30A in the original data Din acquired in step S400 (step S402).

Next, the coordinate replacement section 21E randomly selects the replacement function Rp from the set of replacement functions represented by {0, . . . , nv−1}{0, . . . , nv−1} using the number of pieces of data nv calculated in step S402.

Then, the coordinate replacement section 21E performs the coordinate replacement process (steps S406 to S410) using the replacement function Rp selected in step S404 for each piece of original data Din for the plurality of pieces of original data Din acquired in step S400.

Specifically, the coordinate replacement section 21E reads one unprocessed original data Din among the plurality of pieces of original data Din acquired in step S400 as a processing target (step S406).

Then, the coordinate replacement section 21E performs the processing of steps S408 and S410 for each position coordinate having not been subjected to coordinate replacement in the original data Din to be processed.

In step S406, the coordinate replacement section 21E selects the one position coordinate having not been subjected to coordinate replacement in the analysis target region 30A in the original data Din. Then, the coordinate replacement section 21E sets the data value of the selected position coordinates in the original data Din to the post-replacement position coordinates in the shuffled data Din_shuffled obtained by replacing the position coordinates with the replacement function Rp (step S410). The coordinate replacement section 21E performs these processes for all position coordinates in the analysis target region 30A in the original data Din, thereby generating the shuffled data Din_shuffled.

Then, the coordinate replacement section 21E outputs the shuffled data Din_shuffled generated for each of the plurality of pieces of original data Din to the processing section 21C.

As described above, in the information processing apparatus 10B of the present embodiment, the coordinate replacement section 21E replaces the position coordinates of at least some data values of the plurality of data values in the analysis target region 30A in the original data Din with other position coordinates in the analysis target region 30A. The processing section 21C generates processed data Dout obtained by processing the shuffled data Din_shuffled having position coordinates having been replaced by the coordinate replacement section 21E using the processing pattern Pd.

Therefore, the information processing apparatus 10B of the present embodiment can provide processed data Dout with further improved secrecy and confidentiality, in addition to the effects of the above embodiment.

Furthermore, the coordinate replacement section 21E of the information processing apparatus 10B of the present embodiment generates shuffled data Din_shuffled in which the position coordinates of the data value in the analysis target region 30A in the original data Din are replaced with other position coordinates in the analysis target region 30A, for each of the plurality of pieces of original data Din acquired by the acquisition section 20A, using the replacement function Rp. That is, the coordinate replacement section 21E of the present embodiment performs the coordinate replacement process on the plurality of pieces of original data Din acquired by the acquisition section 20A using the same replacement function Rp to generate the shuffled data Din_shuffled.

Therefore, a distance L1 and a distance L2 between the plurality of pieces of original data Din acquired by the acquisition section 20A coincide with a distance L1 and a distance L2 between the plurality of pieces of shuffled data Din_shuffled generated by the coordinate replacement process. Note that the L1 distance is a value used at the time of clustering data, and is a Manhattan distance between data feature amounts. Note that the distance L2 is a value used at the time of clustering data, and is a Euclidean distance between data feature amounts. The distance L2 is the shortest distance between the data feature amounts.

Then, in the information processing apparatus 10B of the present embodiment, the processing section 21C generates processed data Dout obtained by processing the shuffled data Din_shuffled using the processing pattern Pd.

Therefore, the information processing apparatus 10B of the present embodiment can provide the processed data Dout in which it is difficult to estimate confidential information while reducing the influence on the data analysis method based on the distance between data.

Next, an example of a hardware configuration of the information processing apparatus 10 and the information processing apparatus 10B in the above-described embodiments and a modified example will be described.

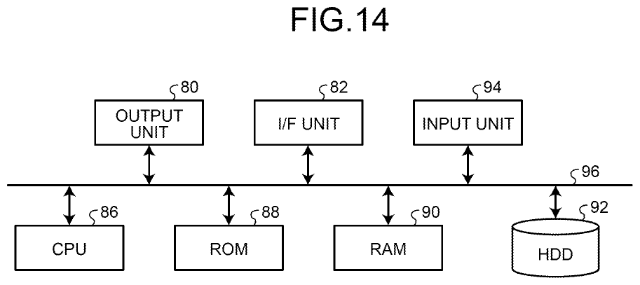

FIG. 14 is a hardware configuration diagram of an example of the information processing apparatus 10 and the information processing apparatus 10B according to the embodiments and the modified example.

The information processing apparatus 10 and the information processing apparatus 10B include a control device such as a CPU 86, a storage device such as a read only memory (ROM) 88, a random access memory (RAM) 90, and a hard disk drive (HDD) 92, an I/F unit 82 which is an interface with various devices, an output unit 80 which outputs various types of information such as output information, an input unit 94 which receives an operation by a user, and a bus 96 which connects the respective units, and have a hardware configuration using a general computer.

In the information processing apparatus 10 and the information processing apparatus 10B, the CPU 86 reads a program from the ROM 88 onto the RAM 90 and executes the program, whereby the above-described respective units are realized on a computer.

Note that the programs for executing the above-described respective processes executed by the information processing apparatus 10 and the information processing apparatus 10B may be stored in the HDD 92. Furthermore, the program for executing each of the above-described processes executed by the information processing apparatus 10 may be provided by being incorporated in the ROM 88 in advance.

Furthermore, the program for executing the above-described processes executed by the information processing apparatus 10 and the information processing apparatus 10B may be stored as a file in an installable format or an executable format in a computer-readable storage medium such as a CD-ROM, a CD-R, a memory card, a digital versatile disk (DVD), or a flexible disk (FD) and provided as a computer program product. Furthermore, the program for executing the above-described processing executed by the information processing apparatus 10 and the information processing apparatus 10B may be stored on a computer connected to a network such as the Internet and provided by being downloaded via the network. Furthermore, a program for executing the above-described processes executed by the information processing apparatus 10 and the information processing apparatus 10B may be provided or distributed via a network such as the Internet.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information processing method executed by a computer, the method comprising
generating processed data obtained by processing original data including a group of a plurality of data values arranged respectively at position coordinates along a predetermined direction on a map, using a processing pattern in which a processing rule of the original data is defined for each position coordinate on the map.

2. The method according to claim 1, wherein
the processing pattern is
a pattern defining the processing rule for processing a data value in the original data into a processed data value in the processed data for each position coordinate.

3. The method according to claim 2, wherein
the processing pattern is
a pattern defining any of a retainment code representing that the data value in the original data is to be used as it is, a deletion code representing that the data value is to be deleted, or a non-analysis target code representing that the data value is not to be analyzed, for each position coordinate.

4. The method according to claim 3, wherein
the processing pattern is a pattern in which
the retainment code is defined at the position coordinates in a region having a shape similar to a shape of an analysis target region in the original data, and
the non-analysis target code or the deletion code is defined in an outer periphery of the region in which the retainment code is defined.

5. The method according to claim 2, wherein
the generating includes
generating the processed data using, according to the original data, one of a plurality of processing patterns with processing rules that are at least partially different from one another.

6. The method according to claim 2, wherein
the generating includes
generating the processed data using one of a plurality of processing patterns with processing rules that are at least partially different from one another, the one having a data size matching a data size of the original data.

7. The method according to claim 2, further comprising
outputting a plurality of processing patterns having different processing rules, to an output unit,
wherein the generating includes
generating the processed data using one selected from the plurality of output processing patterns.

8. The method according to claim 2, further comprising
outputting the processing pattern used for processing the original data in the generating, to an output unit.

9. The method according to claim 1, wherein
the predetermined direction includes
K-dimensional directions including a first direction on the map and a second direction intersecting the first direction, K being an integer of 2 or more.

10. The method according to claim 1, wherein
the predetermined direction is
a one-dimensional direction on the map.

11. The method according to claim 1, further comprising
replacing position coordinates of at least part of a plurality of data values in an analysis target region in the original data with other position coordinates in the analysis target region,
wherein the generating includes
generating the processed data obtained by processing shuffled data in which the position coordinates are replaced at the replacing, using the processing pattern.

12. An information processing apparatus comprising
one or more hardware processors configured to generate processed data obtained by processing original data including a group of a plurality of data values arranged respectively at position coordinates along a predetermined direction on a map, using a processing pattern in which a processing rule of the original data is defined for each position coordinate on the map.

13. A computer program product comprising a computer-readable medium including programmed instructions, the instructions causing a computer to execute
generating processed data obtained by processing original data including a group of a plurality of data values arranged respectively at position coordinates along a predetermined direction on a map, using a processing pattern in which a processing rule of the original data is defined for each position coordinate on the map.
